(19) United States
(12) Patent Application Publication
(10) Pub. No.: US 2003/0195065 A1
(43) Pub. Date: Oct. 16, 2003

(54) Sports racquet having a rubber wrap grip

(76) Inventor: Stephen J. Davis, Treviso (IT)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 10/124,760

(22) Filed: Apr. 16, 2002

(51) Int. Cl. A63B 49/08; B32B 1/00

(52) U.S. Cl. 473/549; 428/141

(57) ABSTRACT

A grip for a handle of a sports racquet comprises an elongated strip of molded rubber sized for wrapping spirally about an elongated handle of a sports racquet such that its bottom surface contacts said handle and its upper surface forms a gripping surface for the hand. Preferably, the upper surface is molded with an aggressively textured surface to enhance gripping power.

### BACKGROUND OF THE INVENTION

The present invention relates to sports racquets such as tennis racquets, squash racquets, badminton racquets, and racquetball racquets having a head portion a handle covered by a grip forming an outer surface for the player to grasp.

In the case of racquetball racquets, there are currently two types of grips, the wrapped grip and the slide-on grip. Wrap grips are typically formed by depositing a thin layer of polyurethane over a cushioned felt backing. This type of grip is spirally wrapped around the racquet handle. The polyurethane material, which forms the outer surface of the grip, provides reasonably good slip resistance, while the felt backing provides a cushioned feel. The wrap grip is also moisture absorbent and easy to install.

The other type of grip is a slide-on grip molded out of rubber or some type of elastomeric material such as Kraton®M. These rubber grips are molded into a tubular, sleeve-like shape, and installed by sliding the sleeve over the butt end of the handle. Because tubular grips are formed by molding, it is possible to provide the outer surface with a textured surface so that the racquet is less likely to slip out of the player's hand. Such grips can also be made thicker than wrap grips, to resist abrasive wear, for greater durability. The chief drawbacks of rubber, tubular grips are that they do not absorb moisture and they can be difficult to install, requiring a solvent and sometimes extra tools to slide the grip over the flared butt cap.

### BRIEF SUMMARY OF THE INVENTION

A grip for a handle of a sports racquet comprises an elongated strip of molded rubber material sized for wrapping spirally about an elongated handle of a sports racquet such that its bottom surface contacts the handle and its upper surface forms a gripping surface for the hand. Preferably, the upper surface is molded to have an “aggressively textured surface” to enhance gripping power.

As used in the specification and claims, the term “aggressively textured surface” means a pattern of surface indentations or projections of sufficient density and depth (or height, in the case of projections) so that, when the hand or glove of a player grasps the racquet, the skin or glove of the player is deformed locally to protrude into such indentations. In this manner, there is positive engagement between the grip and the player's hand, and not merely friction, thereby increasing gripping power. Such indentations can be in the form of holes, grooves, slots, or channels, or any combination thereof. Projections can be of any shape, for example creating a knurled surface.

In a preferred embodiment, the opposed longitudinal edges of the strip have complementary shape such that, when such grip is wound spirally on a handle and an edge of a spiral turn overlaps an edge of a prior spiral turn, such overlapping edges have the same thickness as the adjoining portions of the strip.

In another preferred embodiment, at least one of the opposed longitudinal edges of the strip, when viewed in cross-section, has an upper convex surface such that, when such grip is wound spirally on a handle, the concave edge presses against the handle.

If desired, the strip may be made of a transparent rubber. In such embodiment, the outer surface of the handle will be visible, and may include a design, logo, or the like. Also, the outer surface of the strip, along part or all of the length of the strip, may be smooth rather than textured.

Preferably, the rubber material is selected from a group of rubber materials having a tack, such that said grip can be wound on a handle without the need for an adhesive. Optionally, the grip may have a backing material on its bottom surface, for example, felt or a rubber or other elastomer material softer than the rubber material of said strip.

In another preferred embodiment, the strip has regions of differently colored rubber materials, or regions of different rubber materials having physical properties different from one another.

For a better understanding of the invention, reference is made to the following detailed description of the preferred embodiments of the invention, taken in conjunction with the drawings accompanying the application.

### BRIEF DESCRIPTION OF THE SEVERAL VIEWS OF THE DRAWINGS

FIG. 1 is a front view of a racquetball racquet;

FIG. 2 is a top view of a grip according to the invention;

FIG. 3 is a bottom view of the grip;

FIG. 4 is a cross-sectional view, taken through lines 4-4 of FIG. 2;

FIG. 4a is a cross-sectional view taken through lines 4a-4a of FIG. 2

FIG. 5 is a cross-sectional view, taken through lines 5-5 of FIG. 2;

FIG. 6 is a perspective view of a portion of the grip shown in FIG. 2;

FIG. 7 is an enlarged view of the grip pattern employed with the embodiment of FIG. 2;

FIG. 8 is a side view of a portion of the butt end of a racquet handle, with a grip according to FIG. 2 partially wrapped onto the handle;

FIG. 9 is a side view of another portion of the handle of FIG. 8, showing the wrapping of the grip in progress;

FIG. 10 is a top view of another embodiment of a grip;

FIG. 11 is a top view of yet another embodiment of a grip;

FIG. 12 is a cross-sectional view of a still further embodiment of a grip; and

FIG. 13 is a cross-sectional view of another embodiment of a grip.

### DETAILED DESCRIPTION OF THE INVENTION

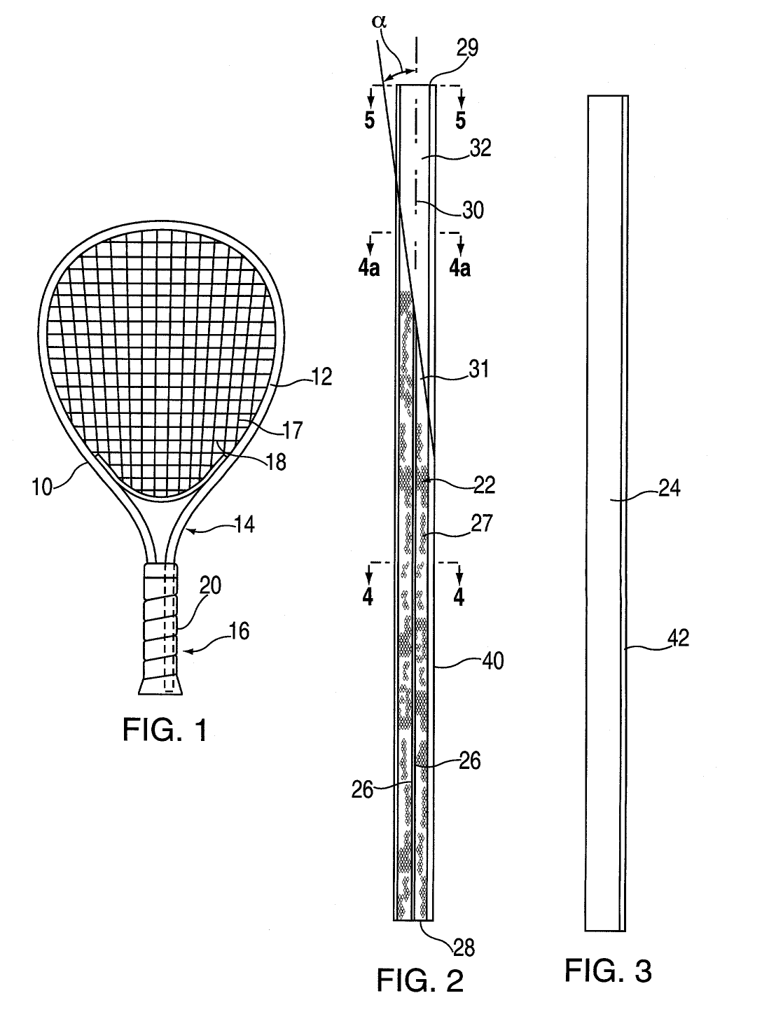

FIG. 1 shows a racquetball racquet 10 which has a head portion 12, a throat region 14 formed by a pair of converging shafts, and a handle 16. A plurality of main strings 17 and cross strings 18 are interwoven to form a string bed, and a grip 20 is spirally wound around the handle 16.

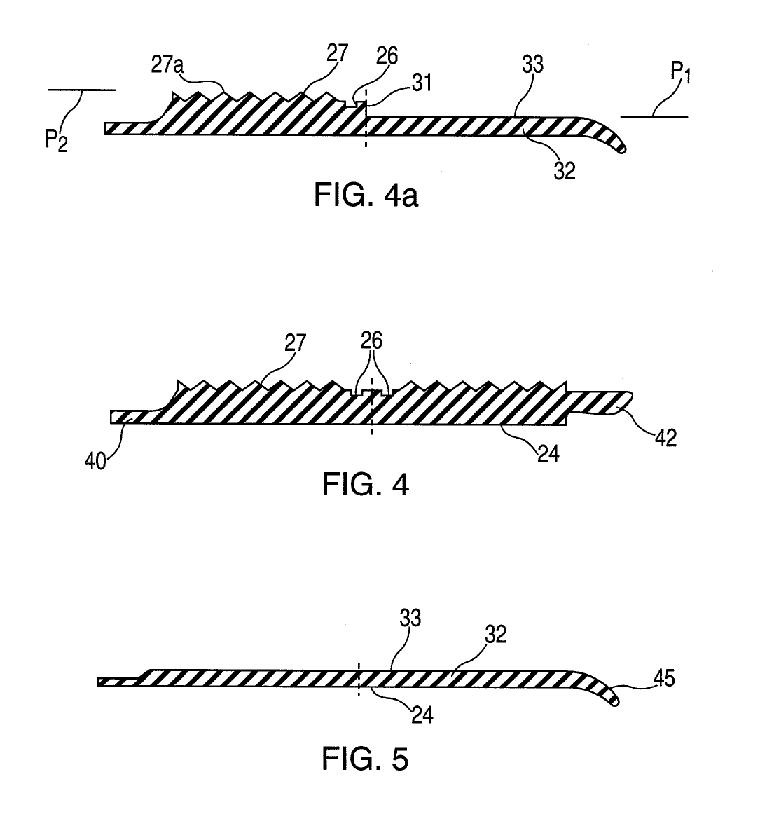

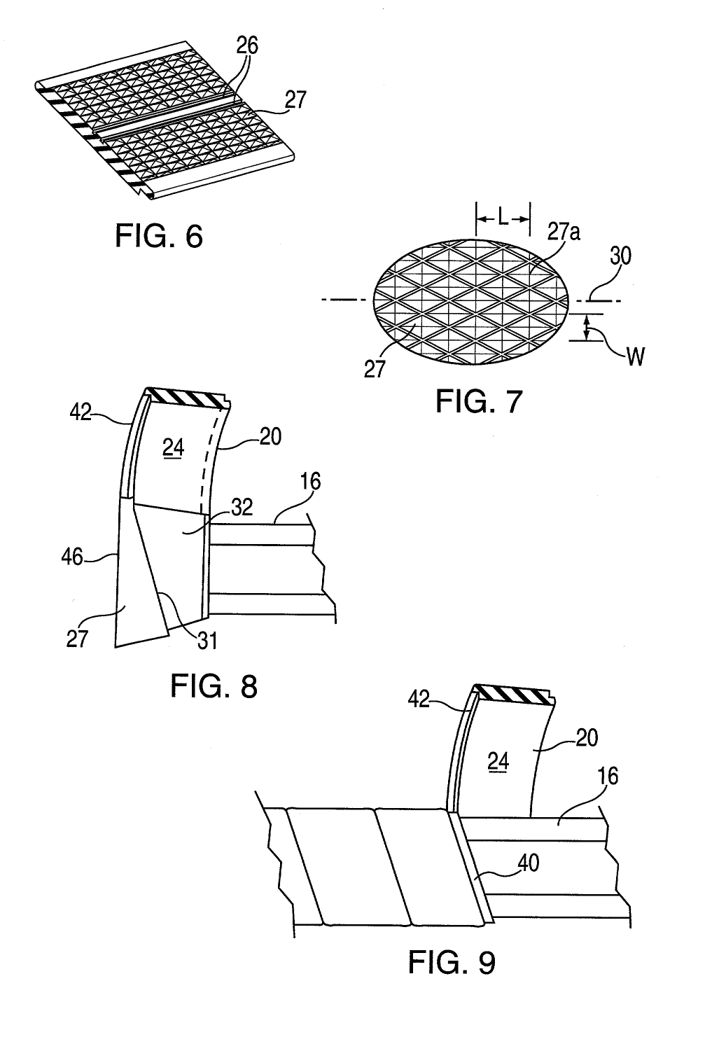

FIGS. 2 and 3 show the top surface 22 and bottom surface 24, respectively, of the grip 20 prior to being wound onto the handle 16. As shown in FIG. 3, the bottom surface 24, which abuts against the surface of the handle when the grip 20 installed on the racquet 10, may be smooth. The upper surface 22, however, has an “aggressively textured surface.” In FIG. 2, the aggressively textured surface is represented by a plurality of channels 26 and an array of pyramid shaped grip elements 27. The channels 26 and pyramid shaped grip elements 27 are shown in more detail in FIGS. 4, 6 and 7, discussed further below.

As shown in FIG. 2, the channels 26 and pyramid shaped grip elements 27, which form a gripping portion of the grip, extend from a rear end 28 of the grip towards a forward end 29 of the grip, terminating along a boundary line 31 which is at an acute angle α relative to the longitudinal axis 30 of the grip 20. As explained further below, the angle α corresponds to the desired wind angle of the grip on the handle 16. A leader portion 32 of the grip 20, which is the portion located between the boundary line 31 and the forward end 29 of the grip 20, has a smooth upper surface 33 and, as shown in FIG. 4A, lies in a plane “P1” which is below the plane “P2” in which the upper tips 27a of the pyramid shaped grip elements 27 lie.

Referring to FIGS. 4 and 6-7, in the illustrated embodiment the pyramid shaped grip elements 27 are oriented at a 45 degree angle relative to the longitudinal axis 30 of the grip 20, and the base of the pyramid shaped grip elements 27 have a length “L” which is greater than their width “W,.” e.g., a length “L” of 2.4 mm and a width of 1.2 mm. However, such orientation, dimensions, and shape are merely illustrative.

As shown in FIGS. 4, in the gripping portion the grip 20, i.e., the portion containing the pyramid shaped grip elements 27, each of the opposite sides of the grip 20 are provided with a recessed edge 40, 42. The upwardly facing recessed edge 40 (which will be the upper edge when the grip 20 is wound on the handle 16, as described below) has a thickness of 0.6 mm, whereas the downwardly facing recessed edge 42 will have a thickness of approximately 1 mm.

As shown in FIGS. 4 and 4A, one edge 45 of the leader portion 32, which forms the lower edge of the grip 20 when the grip is wound onto a handle 16, curls downwardly, toward the lower surface 24. This is to cause the edge 45 to press against the surface of the handle when the grip 20 is wound onto the handle.

The process for winding the grip 20 onto the handle 16 is illustrated in FIGS. 8 and 9. Starting with the forward end 29 of the rubber grip 20, the lead portion 32 is wound about the butt end 46 of the racquet handle 16. Initially, the grip 20 is wound perpendicular to the handle axis. As shown in FIG. 8, after the initial wind, the textured surface 27 adjacent boundary line 31 begins to appear. On the next ensuing wrap, the recessed edge 42 on the underside 24 of the wrap 20 will encounter the vertical surface of the boundary line 31. The boundary line 31 extends at the desired wind angle for the grip. As the grip is wound, the recessed edge 42 will abut and engage the boundary line 31, causing the grip 20 to follow the boundary line 31 and be wound in a spiral fashion.

As shown in FIG. 9, once the grip 20 is reoriented to wrap in a spiral manner about the handle 16, it will continue to wrap spirally. As the grip 20 is wrapped, the upper recessed edge 42 will overlie the lower recessed edge 40 of the prior wrap, to form a flush joint. Other forms of mating edges may be used in place of the mating recessed edges if desired.

Thus, the boundary line 31 acts a guide initially to cause the grip 20 to follow the desired wrap angle. Thereafter, the engaging recessed edges 40, 42 align subsequent wraps to the correct wind angle.

The grip 20 may have a conventional length, width, and thickness. By way of example, if the grip 20 is to be used for racquetball racquets, it may have a length of 700 mm, a width of 25 mm, and a thickness of 0.7 mm at the leader portion and 2.00 mm in the gripping portion (where there are no recessed edges). The grooves 26 preferably have a depth between 10% and 40%, and most preferably about 20%, of the thickness of the grip 20. If the grip 20 is to be used for other types of racquets, the dimensions would be selected accordingly.

The grip 20 is made entirely of rubber, preferably natural rubber.

Alternatively, the grip may be made of other elastomeric materials (synthetic rubber) such as Kraton®. Preferably, the material has a hardness in the range of Shore A35 to A60, most preferably Shore A49. The grip 20 is manufactured by injecting rubber material into a mold defining the channels 26 and textured upper surface. The mold may be in the shape of an individual grip 20. Alternately, the mold can form a sheet of material containing channels 26, which sheet is then cut into individual strips.

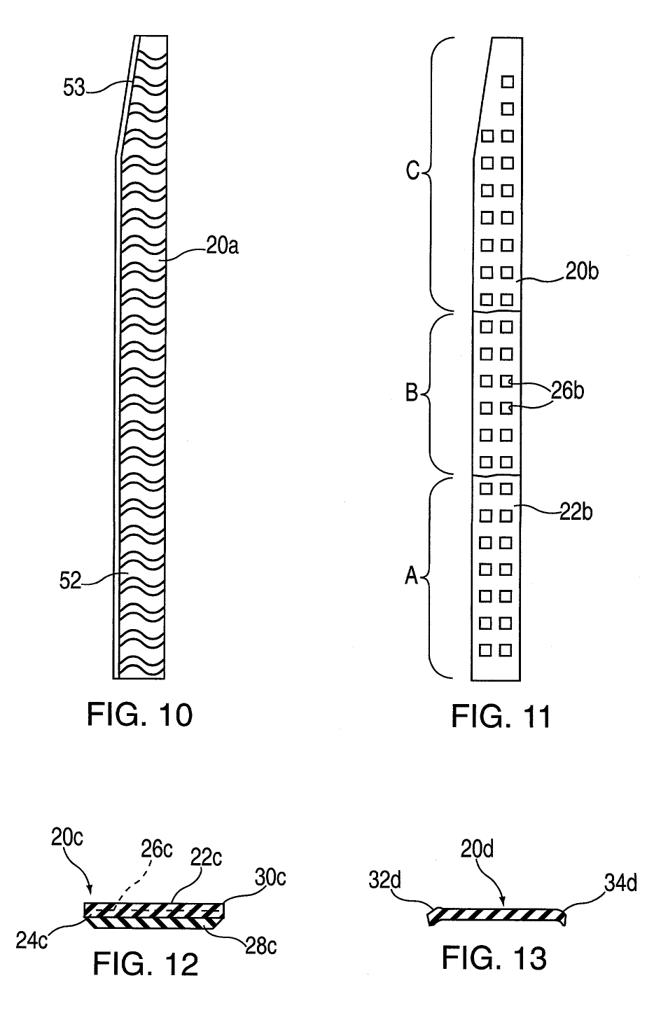

FIG. 10 shows a modified grip 20a, in which the textured upper surface 52 is formed by a plurality of channels which are oriented generally perpendicular to the longitudinal axis of the grip. Grip 20a also differs from grip 20 insofar as, rather than providing a leader section and boundary line guide, the forward end 52 of the grip is tapered at the desired wind angle. The opposite edges of the grip 20a may be notched in a manner similar to grip 20, so that overlapping edges form a flush joint. Such grip 20a is wound in a conventional fashion on the racquet handle, starting at the tapered end.

FIG. 11 shows another alternative of a grip 20b. In place of channels, a plurality of knob-like projections 26b extend from the upper surface 22b of the grip 20b. In addition, the grip 20b contains regions A, B, and C which are formed of rubber materials having properties different from one another. For example, the rubber materials used in the respective regions may be of different colors, or have different hardnesses. Such grip 20b may be formed by injecting simultaneously the different materials into the mold through separate ports.

FIG. 12 shows another alternative grip 20c which includes a rubber strip 30c which may be identical to the grip 20, 20a, or 20b. In addition, a backing material 28c is adhered to the bottom surface 24c of the strip 30c for extra cushioning. The backing material 28c may be felt of the type used in polyurethane grips, or may be a soft rubber material. In this manner, the strip 30c containing the texture 26c can be formed of a relatively harder rubber for greater durability, and the backing material 28c will provide a softer feel. The backing may also contain an adhesive. As shown, the edges of the grip may be skived in a known manner.

FIG. 13 is a cross-sectional view of another rubber grip 20d, in which the grip is molded so that the opposed longitudinal edges have upper convex surfaces 32d, 34d. In this manner, when the grip 20d is wrapped around the handle, the edges 32d, 34d apply pressure against the handle surface so that the grip 20d remains in tight engagement with the handle.

If desired, the grip can be transparent or tinted, so as to expose the underlying handle surface. The outer surface of the handle can be provided with the desired color, or may contain written or graphic indicia which will be exposed through the transparent or tinted grip. Also, if desired the outer surface of the grip, along part or all of its length, may be smooth rather than textured.

The foregoing represent preferred embodiments of the invention. Variations and modifications will be apparent to persons skilled in the art, without departing from the inventive concepts disclosed herein. For example, the disclosed grip can also be used as an overgrip, i.e., wound over an existing racquet grip. Also, in certain applications it may be desirable to employ an adhesive or double face tape between the grip and handle, particularly if the grip is wrapped directly on the handle. All such modifications and variations are intended to be within the scope of the invention, as defined in the following claims.

1. A grip for a handle of a sports racquet comprising:
an elongated strip of molded rubber having top and bottom surfaces and having a length, width, and thickness sized for wrapping spirally about an elongated handle of a sports racquet such that said bottom surface bears against said handle and said upper surface forms a gripping surface for the hand

2. A grip according to claim 1, wherein said upper surface has an aggressively textured surface to enhance gripping power.

3. A grip according to claim 1, wherein said strip has opposed longitudinal edges of complementary shape such that, when such grip is wound spirally on a handle such that an edge of a spiral turn overlaps an edge of a prior spiral turn, such overlapping edges have the same thickness as the adjoining portions of the strip.

4. A grip according to claim 1, wherein said strip has opposed longitudinal edges and wherein at least one edge, when viewed in cross-section, has an upper convex surface such that, when such grip is wound spirally on a handle, said one edge applies force against the handle.

5. A grip according to claim 1, wherein such rubber material is selected from a group of rubber materials having a tack, such that said grip can be wound on a handle without the need for an adhesive.

6. A grip according to claim 1, wherein said grip has a backing material on said bottom surface selected from the group of a rubber or other elastomer material softer than the rubber material of said strip and felt.

7. A grip according to claim 1, wherein said strip has regions of differently colored rubber materials.

8. A grip according to claim 1, wherein said strip has regions of different rubber materials having physical properties which are different from one another.

9. A grip according to claim 1, wherein said strip is made entirely of natural rubber.

10. A grip according to claim 1, wherein one end of said grip includes a leader portion and a gripping portion, wherein said leader portion extends from said end and having an upper surface which lies generally in a first plane, wherein said gripping portion has an upper surface which lies generally in a second plane which is above said first plane, and wherein said leader portion and said gripping portion meet along a boundary which is oriented at a angle, relative to the longitudinal axis of the grip, which corresponds to the desired wind angle of the grip.

11. A grip according to claim 10, wherein the lower surface of said wrap includes a notched edge for engaging a surface along said boundary such that, upon wrapping said grip, said grip follows the angle of said boundary.

12. A grip according to claim 1, wherein said top surface is smooth along at least a portion of the length of said strip.

13. A grip according to claim 1, wherein said strip is at least semi-transparent such that, when said grip is mounted on a handle, an outer surface of the handle is visible.

13. A grip according to claim 12, wherein said top surface is smooth along at least a portion of the length of said strip.

14. A grip according to claim 13, wherein said top surface is smooth along at least most of the length of said strip.
